(19) United States
(12) Patent Application Publication
(10) Pub. No.: US 2026/0292919 A1
(43) Pub. Date: Sep. 24, 2026

(54) Methods And Apparatus For Performing Sensing Operations In Mobile Communications

(71) Applicant: MediaTek Singapore Pte. Ltd., Singapore (SG)

(72) Inventors: Wenze Qu, Beijing (CN); Jianwei Zhang, Beijing (CN); Min Lei, Beijing (CN); Tao Chen, Beijing (CN); Shiauhe Shawn Tsai, San Jose, CA (US); Xuanbo Shao, Beijing (CN); Haoran Li, Beijing (CN); Jiaying Ren, San Jose, CA (US)

(73) Assignee: MediaTek Singapore Pte. Ltd., Singapore (SG)

(21) Appl. No.: 19/565,599

(22) Filed: Mar. 13, 2026

(30) Foreign Application Priority Data
Mar. 19, 2025 (WO) PCT/CN2025/083318
Apr. 15, 2025 (WO) PCT/CN2025/089034
Mar. 11, 2026 (CN) 202610296303.5

(51) Int. Cl. H04W 76/27; H04W 24/10

(52) U.S. Cl. CPC H04W 76/27; H04W 24/10

(57) ABSTRACT

Various solutions for performing sensing operations with respect to an apparatus in mobile communications are described. The apparatus may receive a sensing information from a network node. The apparatus may be under a first Radio Resource Control (RRC) state. The apparatus may perform a sensing operation with another apparatus based on the sensing information. The another apparatus may be under a second RRC state.

### CROSS REFERENCE TO RELATED PATENT APPLICATION(S)

The present disclosure is part of a non-provisional application claiming the priority benefit of PCT Application No. PCT/CN2025/083318, filed on 19 Mar 2025, PCT Application No. PCT/CN2025/089034, filed on 15 Apr 2025, and CN Application No. 202610296303.5, filed on 11 Mar 2026, the contents of which herein being incorporated by reference in their entirety.

### TECHNICAL FIELD

The present disclosure is generally related to mobile communications and, more particularly, to performing sensing operations with respect to apparatus in mobile communications.

### BACKGROUND

Unless otherwise indicated herein, approaches described in this section are not prior art to the claims listed below and are not admitted as prior art by inclusion in this section.

In fifth-generation (5G) and sixth-generation (6G) mobile communication systems, Integrated Sensing and Communication (ISAC) has been introduced to enable wireless networks to support both communication services and sensing functionalities. In particular, network nodes and User Equipment (UE) may be equipped with sensing capabilities to perform operations such as ranging, positioning, environment awareness, and target detection by reusing communication signals or by transmitting dedicated sensing signals.

In some scenarios, a sensing-capable device, for example a UE, may be required to perform sensing operations with other network devices (e.g., a Base Station (BS) or other UE(s)). The sensing-capable device may operate under different Radio Resource Control (RRC) modes and may need to perform sensing operations with other UE(s) operating under the same or different RRC modes. However, the corresponding procedures for supporting sensing operation under various RRC modes, as well as the procedures for coordinating sensing operation between devices operating in different RRC modes, have not been clearly defined.

Accordingly, how to design procedures that enable sensing operation between UEs operating in different RRC modes becomes an important issue in newly developed wireless communication networks. There is an urgent need to provide proper schemes to support triggering, configuration, execution, and reporting of sensing operations across different RRC states while maintaining network efficiency and device power optimization.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to performing sensing operations with respect to apparatus in mobile communications.

In one aspect, a method may involve an apparatus receiving a sensing information from a network node. The apparatus may be under a first Radio Resource Control (RRC) state. The method may also involve the apparatus performing a sensing operation with another apparatus based on the sensing information. The another apparatus may be under a second RRC state.

In one aspect, a method may involve an apparatus transmitting a first sensing information to a first apparatus for performing a sensing operation. The first apparatus may be under a first RRC state. The method may also involve the apparatus transmitting a second sensing information to a second apparatus for performing the sensing operation. The second apparatus may be under a second RRC state.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, a sensing information from a network node. The apparatus may be under a first RRC state. The processor may further perform operations comprising performing a sensing operation with another apparatus based on the sensing information. The another apparatus may be under a second RRC state.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a diagram depicting example scenarios under schemes in accordance with implementations of the present disclosure.

FIG. 4 is a diagram depicting example scenarios under schemes in accordance with implementations of the present disclosure.

FIG. 5 is a diagram depicting example scenarios under schemes in accordance with implementations of the present disclosure.

FIG. 6 is a diagram depicting example scenarios under schemes in accordance with implementations of the present disclosure.

FIG. 7 is a diagram depicting example scenarios under schemes in accordance with implementations of the present disclosure.

FIG. 8 is a diagram depicting example scenarios under schemes in accordance with implementations of the present disclosure.

FIG. 9 is a diagram depicting example scenarios under schemes in accordance with implementations of the present disclosure.

FIG. 10 is a diagram depicting example scenarios under schemes in accordance with implementations of the present disclosure.

FIG. 11 is a diagram depicting example scenarios under schemes in accordance with implementations of the present disclosure.

FIG. 12 is a diagram depicting example scenarios under schemes in accordance with implementations of the present disclosure.

FIG. 13 is a diagram depicting example scenarios under schemes in accordance with implementations of the present disclosure.

FIG. 14 is a diagram depicting example scenarios under schemes in accordance with implementations of the present disclosure.

FIG. 15 is a diagram depicting example scenarios under schemes in accordance with implementations of the present disclosure.

FIGS. 16A to 16C are diagrams depicting example scenarios under schemes in accordance with implementations of the present disclosure.

FIGS. 17A to 17C are diagrams depicting example scenarios under schemes in accordance with implementations of the present disclosure.

FIG. 18 is a block diagram of an example communication system in accordance with an implementation of the present disclosure.

FIG. 19 is a flowchart of an example process in accordance with an implementation of the present disclosure.

FIG. 20 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performing sensing operations in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may wirelessly connect to a User Equipment (UE) and a device. The UE may be under a first Radio Resource Control (RRC) state. The device may be under a second RRC state. The network node may: (1) transmit a first sensing information to the UE for performing a sensing operation, and (2) transmit a second sensing information to the device for performing the sensing operation. Based on the received sensing information, the UE under the first RRC state and the device under the second RRC state may perform the sensing operation with each other.

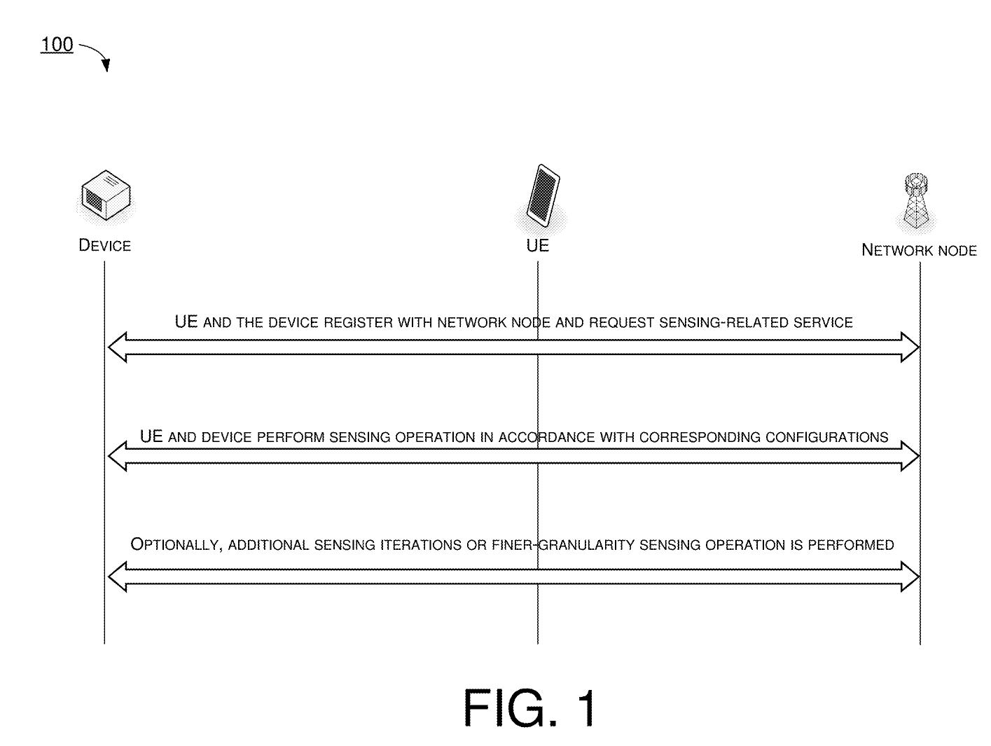

FIG. 1 illustrates an example scenario 100 under schemes in accordance with implementations of the present disclosure. Scenario 100 involves at least one network node, a UE and a device, which may be a part of a wireless communication network (e.g., an LTE network, a 5G/NR network, an IoT network or a 6G network).

Scenario 100 illustrates the current network framework. The network node may wirelessly connect to the UE and the device. It should be noted that, in the figures of the present application, the UE may be illustrated as a smart phone and the device may be illustrated as a smart device. However, such illustrations are provided for explanatory purposes only and are not intended to be limiting. A person skilled in the art would readily understand that the UE may include, but is not limited to, a smart device, and the device may include, but is not limited to, a smart phone.

In addition, in the figures of the present application, the network node may be illustrated as a Base Station (BS). However, this illustration is for explanatory purposes only and is not intended to be limiting. A person skilled in the art would readily understand that the network node may include, but is not limited to, a BS and/or a network server.

In some embodiments, there may be several steps for performing the sensing operation between the UE and the device. In particular, (1) the UE and the device may register with the network node and request a sensing-related service, (2) the UE and the device may perform the sensing operation in accordance with corresponding configurations, and (3) optionally, additional sensing iterations or finer-granularity sensing operations may be performed based on sensing results or network instructions.

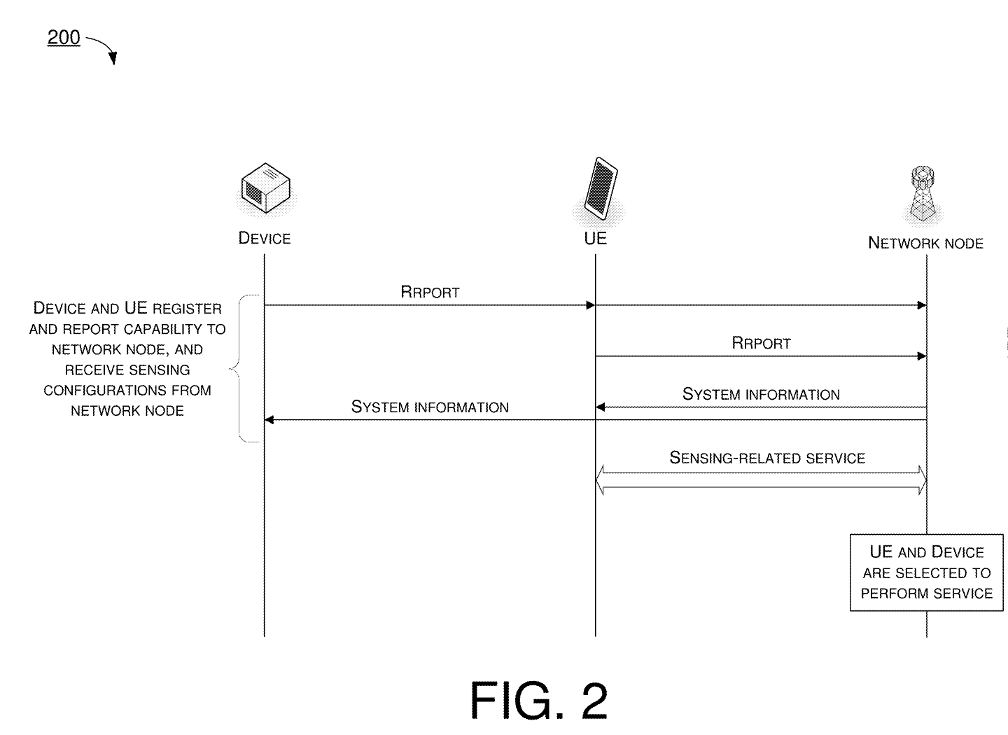

FIG. 2 illustrates an example scenario 200 under schemes in accordance with implementations of the present disclosure. In some implementations, regarding step (1), the UE and the device may respectively register and report capability to the network node. Based on the reports, the network node may respectively transmit system information to the UE and the device. Then, the sensing-related service may be requested between the UE/the device and the network node. The network node may select the UE and the device to perform the corresponding sensing operation.

In some cases, when the network node can receive the report (e.g., the capability) from the device directly, the device may register with the network node through the Random Access (RA) procedure. In other words, when the device can transmit the report (e.g., the capability) to the network node directly, the device may perform the RA procedure with the network node to register with the network node.

In some cases, when the network node is unable to receive the report (e.g., the capability) from the device directly, the report may be forwarded by the UE acting as a relay UE. In other words, when the device cannot transmit the report (e.g., the capability) directly to the network node, the device may transmit the report to the relay UE, which then forwards the report to the network node via various mechanisms, such as A-IoT, sidelink communication, or a non-3GPP interface.

In some cases, the UE may directly communicate with the network node. The UE may register with the network node through the RA procedure.

In some cases, when the first RRC state of the UE includes an idle mode, the network node may obtain a type of the UE but may not obtain service-related capability information from the UE. When the first RRC state of the UE includes an inactive mode or a connected mode, the network node may obtain the type of the UE and the service-related capability information from the UE.

In some cases, when the second RRC state of the device includes an idle mode, the network node may obtain a type of the device but may not obtain service-related capability information. When the second RRC state of the device includes an inactive mode or a connected mode, the network node may obtain the type of the device and the service-related capability information from the device.

In some cases, the UE may receive the sensing configuration from the network node. When the first RRC state of the UE includes an idle mode or an inactive mode, the sensing configuration may be transmitted with a SIB. When the first RRC state of the UE includes a connected mode, the sensing configuration may be transmitted with RRC, Media Access Control-Control Element (MAC-CE) and/or Downlink Control Information (DCI).

In some cases, the device may receive the sensing configuration from the network node. When the second RRC state of the device includes an idle mode or an inactive mode, the sensing configuration may be transmitted with SIB. When the second RRC state of the device includes a connected mode, the sensing configuration may be transmitted with RRC, MAC-CE and/or DCI.

In some cases, the sensing-related service may be initiated by the UE or the network node. The sensing-related service may be centrally controlled by the network node.

In some cases, based on the service requirements of the sensing-related service, the network node may select one or more UE(s) and/or device(s) (e.g., the UE and the device) to participate in the sensing-related service. For example, the network node selects UE(s) and/or device(s) operating in an idle mode within surrounding cells. For another example, the network node selects UE(s) and/or device(s) operating in a connected mode or an inactive mode based on their reported capabilities and position information, which may be obtained from a Location Management Function (LMF).

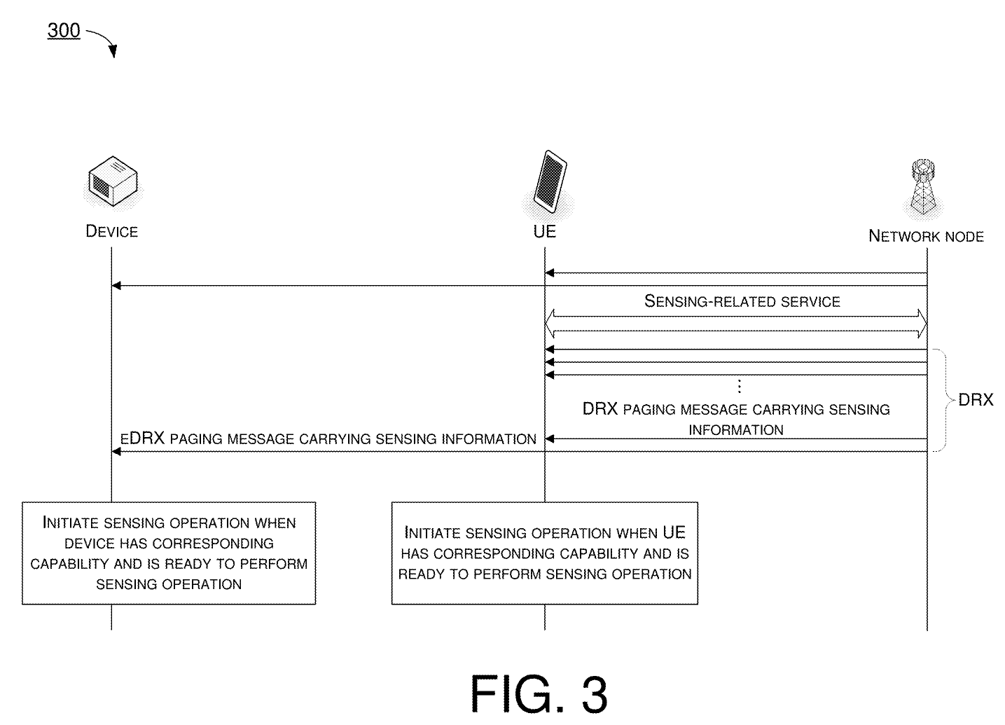

FIGS. 3 to 5 illustrate example scenarios 300, 400 and 500 under schemes in accordance with implementations of the present disclosure. In some implementations, regarding step (2), the UE and the device may be triggered and configured to perform the sensing operation in accordance with corresponding configurations. In particular, the UE under the first RRC state may receive a sensing information from the network node. The device under the second RRC state may receive a sensing information from the network node. Each sensing information may include a sensing configuration and a sensing indication. The sensing information may be carried on at least one of a System Information Block (SIB) and a paging message.

In some cases, as shown in FIG. 3, after receiving the SIB and the sensing-related service is requested, the UE may receive a Discontinuous Reception (DRX) paging message carrying the sensing information. The sensing information may include the sensing configuration and the sensing indication. The UE may initiate sensing operation when the UE has the corresponding capability and is ready to perform the sensing operation. After receiving the SIB and the sensing-related service is requested, the device may receive an extended DRX (eDRX) paging message carrying sensing information. The sensing information may include the sensing configuration and the sensing indication. The device may initiate sensing operation when the device has the corresponding capability and is ready to perform the sensing operation.

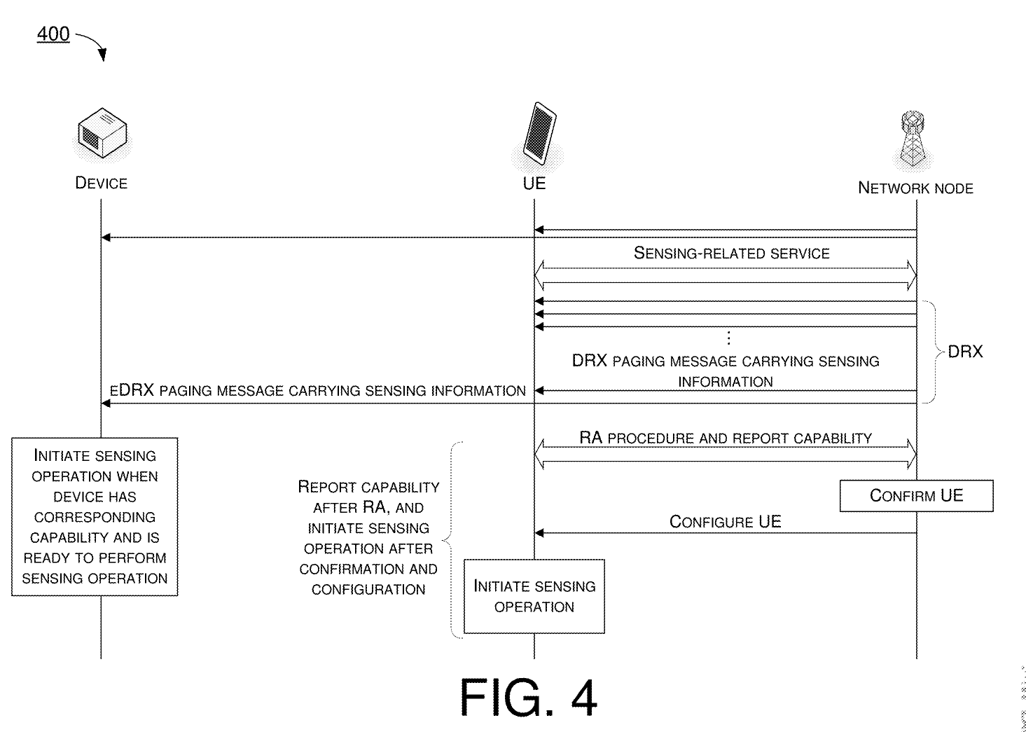

In some cases, as shown in FIG. 4, after receiving the SIB and the sensing-related service is requested, the device may receive an eDRX paging message carrying the sensing information. The sensing information may include the sensing configuration and the sensing indication. The device may start sensing operation when the device has the corresponding capability and is ready to perform the sensing operation.

After receiving the SIB and the sensing-related service is requested, the UE may receive a DRX paging message carrying the sensing information. The sensing information may include the sensing configuration and the sensing indication. The UE may then report capabilities after an RA procedure and initiate sensing operation after being confirmed and configured. More specifically, the UE may perform the RA procedure with the network node. The network node may confirm the UE and configure the UE via RRC, MAC-CE, DCI or paging message. The UE may then perform the sensing operation.

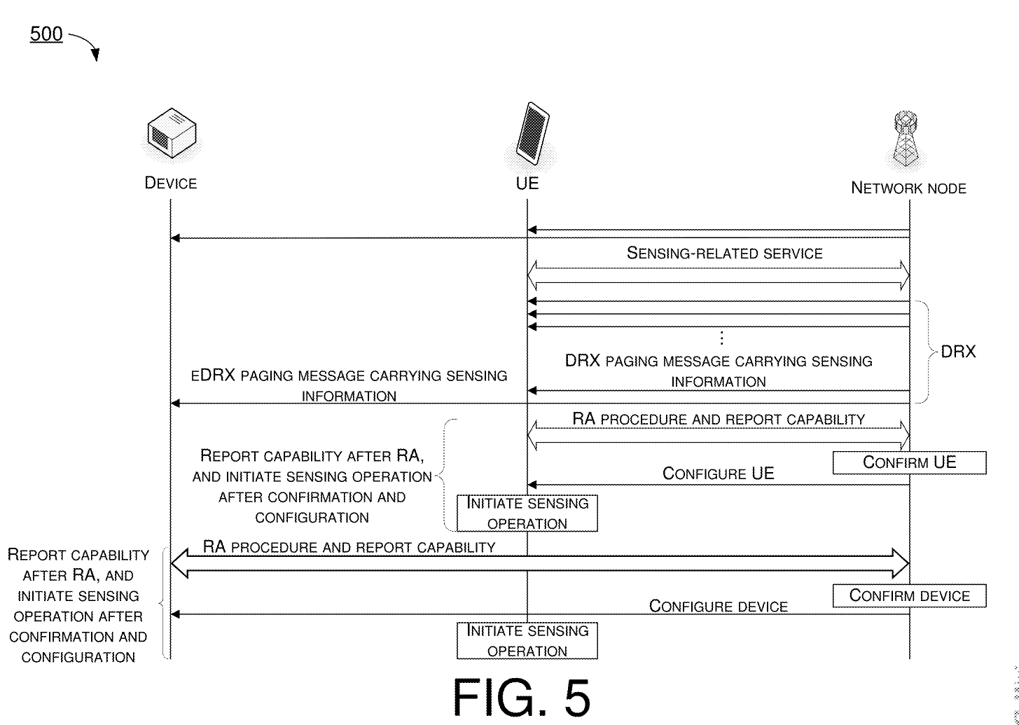

In some cases, as shown in FIG. 5, after receiving the SIB and the sensing-related service is requested, the UE may receive a DRX paging message carrying sensing information. The sensing information may include the sensing configuration and the sensing indication. The UE may then report capabilities after an RA procedure and initiate sensing operation after being confirmed and configured. More specifically, the UE may perform the RA procedure with the network node. The network node may confirm the UE and configure the UE via RRC, MAC-CE, DCI or paging message. The UE may then perform the sensing operation.

After receiving the SIB and the sensing-related service is requested, the device may receive an eDRX paging message carrying the sensing information. The sensing information may include the sensing configuration and the sensing indication. The device may then report capabilities after an RA procedure and initiate sensing operation after being confirmed and configured. More specifically, the device may perform the RA procedure with the network node. The network node may confirm the device and configure the device via RRC, MAC-CE, DCI or paging message. The device may then perform the sensing operation.

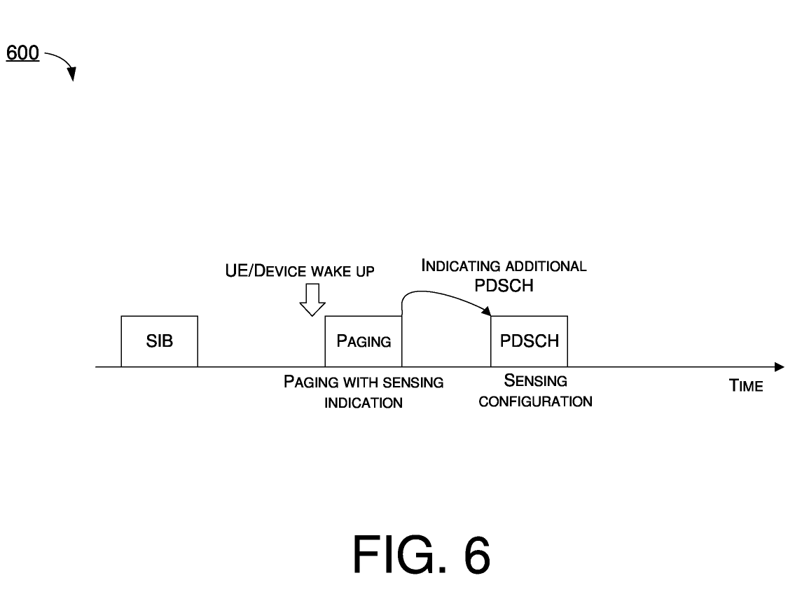

FIG. 6 illustrates an example scenario 600 under schemes in accordance with implementations of the present disclosure. In some implementations, the second RRC state of the device may include an idle mode or an inactive mode, and the device may be configured with eDRX or DRX. The device may be triggered to initiate the sensing operation by the sensing indication carried on the paging message (i.e., page channel) of each or some eDRX/DRX. The sensing configuration may be carried by the SIB and paging message (i.e., page channel).

In some cases, the sensing configuration may be carried on an additional Physical Downlink shared Channel (PDSCH) after paging. In particular, the sensing indication and at least a portion of the sensing configuration may be a bit-field in the paging message. When the payload of the paging message is limited, the paging message may further indicate the additional PDSCH for transmitting the remaining sensing configuration.

More specifically, when the device detects the sensing indication in the paging message, the device may further determine whether the paging message includes an additional indication for receiving the sensing configuration on the PDSCH. When the additional indication is present, the device may receive the sensing configuration via the indicated PDSCH transmitted after the paging message.

In some cases, the UE and the device may respectively receive their own sensing information (i.e., the sensing indications and sensing configurations). When the first RRC state of the UE includes an idle mode or inactive mode, the sensing information may be carried by the SIB or page message.

In some cases, the sensing indication and the configuration may include at least one of: (1) flag of service, (2) matched identification, (3) sensing way, (4) Transmitting (TX) signal and resource configuration, (5) transmission and reception windows, (6) fixed latency between reception of the UE’s TX signal and transmission of the device’s TX signal, and (7) sensing report configuration.

In some cases, the flag of service may be used to trigger the initiation of the corresponding service and indicate the purpose of sensing or the service type.

In some cases, the matched identification may be used to indicate that one device may correspond to multiple UEs, and one UE may correspond to multiple devices.

In some cases, the sensing ways, which may have corresponding procedures and operations, may include Time of Arrival (ToA), Time Difference of Arrival (TdoA), Angle of Arrival (AoA), Round-Trip Time (RTT), and Received Signal Strength Indicator (RSSI) for device ranging and positioning, as well as delay, Doppler, and angle estimation for target detection and tracking.

In some cases, the TX signal and resource configuration may include time-domain and frequency-domain resource allocation, sequence identification, power settings, and related transmission parameters. The TX signal and resource configuration may include configurations for both the device’s TX signals and the UE’s TX signals. For example, a Random Access Channel (RACH) preamble may be used as the TX signal for the sensing-related service. A SIB may carry candidate preamble sequence groups associated with the service, and a paging message may indicate a selected preamble identifier and corresponding time and/or frequency resources.

In some cases, the transmission and reception windows may be configured for the device and the UE. The transmission and reception windows may include at least one of a start time, a window length, and a duration parameter indicating that the corresponding operation is to be performed within one or more subsequent DRX and/or eDRX cycles.

In some cases, the sensing report configuration may include at least one of: report quantities, reporting mechanisms (e.g., via RA, Uplink Control Information (UCI) similar to positioning procedures, uplink data transmission, or Small Data Transmission (SDT)), latency requirements, and resource allocations for reporting.

In some implementations, the first RRC state of the UE may include an idle mode, and the second RRC state of the device may include an idle mode or an inactive mode. The UE may be triggered via the sensing indication carried on the paging message in some DRX. The sensing configuration may also be configured via the SIB and the paging message channel (or the additional PDSCH).

In some cases, the process of triggering and configuring the UE and/or the device to initiate sensing operation, as well as the sensing indication and the sensing configuration, may share a common mechanism for the device.

In some cases, the sensing indication transmitted to the UE may be delivered during a DRX occasion corresponding to the eDRX or DRX occasion in which the sensing indication is transmitted to the device.

In some cases, after the sensing indication and the sensing configuration are received, the UE may have two kinds of processes before initiating the sensing operation.

In some cases, as shown in FIG. 3, when both the UE and the device have the capability and are ready to perform the sensing operation, the UE and the device may directly initiate the sensing operation based on the corresponding sensing configurations.

In some cases, as shown in FIG. 4, when the UE is ready to perform the sensing operation, the UE may initiate RA and report related capabilities to the network node. The network node may determine whether the UE is suitable for the sensing operation according to the UE’s capabilities and position information (e.g., obtained from LMF). When the UE is selected, the UE may be configured by a network node via RRC, MAC-CE, and/or DCI (when the first RRC state of the UE includes a connected mode) or via a paging message (as shown in FIG. 6) (when the first RRC state of the UE includes an inactive mode) if needed. Then, the UE may initiate the sensing operation based on the corresponding configurations. In some cases, the UE may stay in connected mode or inactive mode to perform the sensing operation. When the device has the capability and is ready to perform the sensing operation, the device may directly initiate the sensing operation based on the corresponding sensing configurations.

In some cases, as shown in FIG. 5, when both the UE and the device are ready to perform the sensing operation, the UE and the device may respectively initiate RA and report related capabilities to the network node. The network node may determine whether the UE and the device are suitable for the sensing operation according to the UE’s/device’s capabilities and position information (e.g., obtained from LMF). When the UE and the device are selected, the UE and the device may be configured by network node via RRC, MAC-CE, and/or DCI (when the first RRC state of the UE and the second RRC state of the device respectively include a connected mode) or via paging message (as shown in FIG. 6) (when the first RRC state of the UE and the second RRC state of the device respectively include an inactive mode) if needed. Then, the UE and the device may initiate the sensing operation based on the corresponding configurations. In some cases, the UE and the device may stay in connected mode or inactive mode to perform the sensing operation.

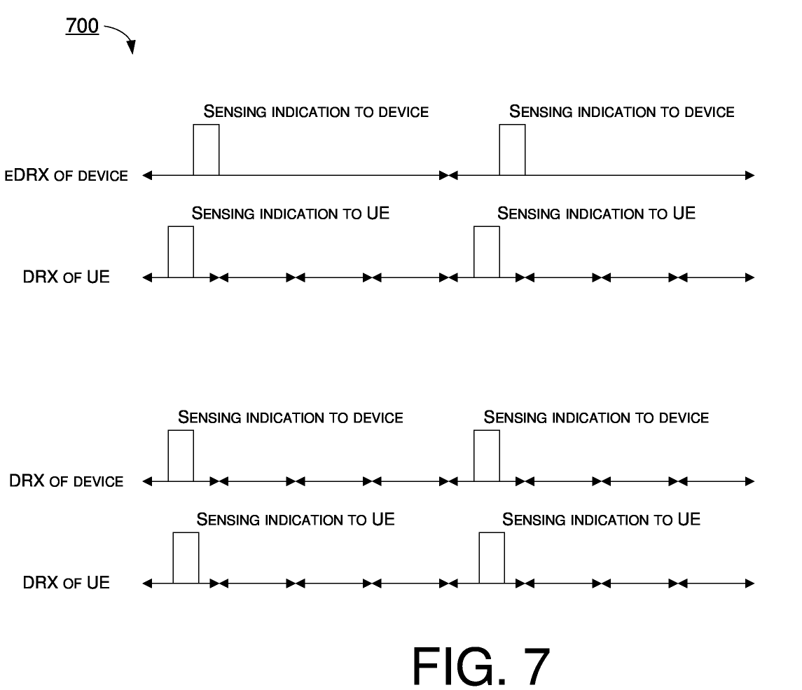

FIG. 7 illustrates an example scenario 700 in accordance with implementations of the present disclosure. In some implementations, the sensing indication transmitted to the UE may be delivered during a DRX occasion corresponding to the eDRX or DRX occasion in which the sensing indication is transmitted to the device. The respective occasions of the sensing indications for the UE and the device are illustrated in FIG. 7.

In some implementations, the first RRC state of the UE may include an inactive mode, and the second RRC state of the device may include an idle mode or an inactive mode. The UE may be triggered via the sensing indication carried on the paging message of some DRX. The sensing configurations may be configured via SIB and paging message (or the additional PDSCH).

In some cases, after the sensing indication and the sensing configuration are received, when the UE has the capability and is ready to perform the sensing operation, the UE may directly initiate the sensing operation based on the corresponding sensing configurations.

In some cases, the first RRC state of the UE may include the inactive mode. In such a case, the network node may have access to sensing capability information and position information of the UE (e.g., previously reported by the UE), and may directly select the UE for the sensing operation. Accordingly, after receiving the sensing indication and corresponding configurations, the UE may directly initiate the sensing operation when it is ready, for example, when no higher-priority task is pending

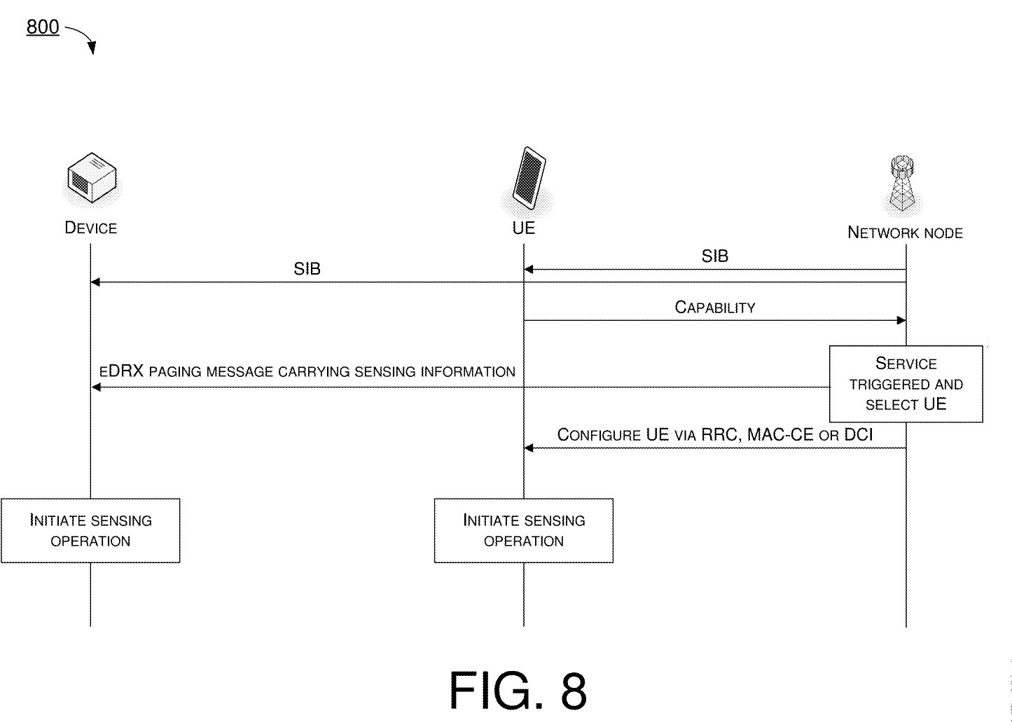

FIG. 8 illustrates an example scenario 800 in accordance with implementations of the present disclosure. In some implementations, the first RRC state of the UE may include a connected mode, and the second RRC state of the device may include an idle mode or an inactive mode. Based on previous reporting by the UE, the network node may obtain sensing capability information and position information of the UE, for example, from LMF. When the service is triggered, the network node may select the UE according to the UE’s capabilities and position information, and may trigger and configure the UE via RRC, MAC-CE, or DCI. Thereafter, the UE and the device may initiate the sensing operation in accordance with the corresponding configurations.

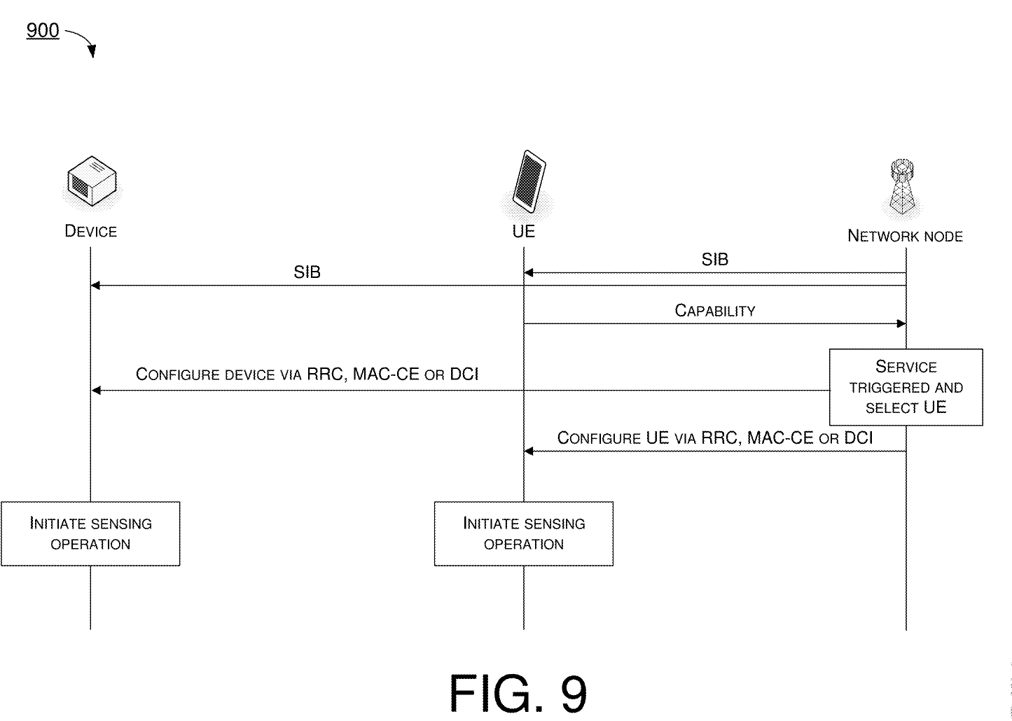

FIG. 9 illustrates an example scenario 900 in accordance with implementations of the present disclosure. In some implementations, the first RRC state of the UE may include a connected mode, and the second RRC state of the device may also include a connected mode. Based on previous reporting by the UE and the device, the network node may obtain sensing capability information and position information of both the UE and the device, for example, from LMF. When the service is triggered, the network node may select the UE and the device according to their respective capabilities and position information, and may trigger and configure the UE and the device via RRC, a MAC-CE, or DCI. Thereafter, the UE and the device may initiate the sensing operation in accordance with the corresponding configurations.

In some implementations, the UE and the device may perform the sensing operation in accordance with corresponding configurations. In particular, there may be at least two types of sensing operations associated with different sensing ways. In some cases, a first type of sensing operation may include that the device does not receive signals transmitted by the UE. This type may correspond to sensing ways such as ToA, TdoA, AoA, RSSI for device ranging and positioning, as well as delay, Doppler, and angle estimation for target detection and tracking. In some cases, a second type of sensing operation may include that the device receives signals transmitted by the UE. This type may correspond to a sensing way, such as Round-Trip Time (RTT) for device ranging and positioning, and may also support delay, Doppler, and angle estimation for target detection and tracking.

In some cases, the second type of sensing operation may include at least two schemes. In particular, a first scheme may include that the device transmits the TX signal twice, and a second scheme may include that the device transmits the TX signal once.

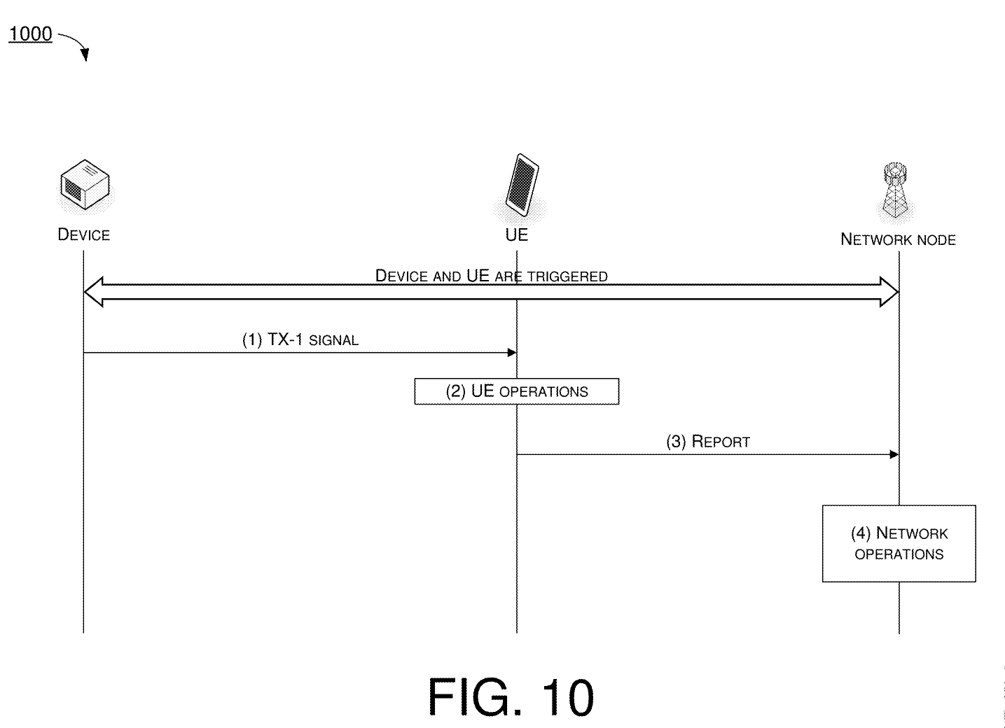

FIG. 10 illustrates an example scenario 1000 in accordance with implementations of the present disclosure. In some implementations, the first type of sensing operation may be performed when the first RRC state of the UE and the second RRC state of the device include an idle mode or an inactive mode. In particular, after being triggered, the device may transmit a signal to the UE. The UE may receive the signal from the device, determine a sensing data based on the signal, and report the sensing data to the network node.

More specifically, as shown in FIG. 10, (1) the device may transmit the TX-1 signal based on the corresponding sensing configurations. (2) the UE may search for (i.e., receive) the device’s TX-1 signal in the configured reception window after paging. It should be noted that more than one UE may be configured to perform the sensing operation. Some UEs located in proximity to the device may detect the TX-1 signal, process the received signal, and derive sensing data accordingly. The sensing data may include at least one of a delay parameter, a Doppler parameter, an angle parameter, and an RSSI parameter, depending on the applied sensing way. Such sensing data may be used to determine a final sensing result, for example, a range or position of the device and/or a position of a target. (3) the UE may report the sensing data to the network node. (4) the network node may receive the sensing report, perform integration and calculation to determine the device’s range and/or position, and may further report the result to a server, if present. In some cases, the network node may directly forward the sensing report to the server, and the server may perform the calculation of the device’s range and/or position. The calculation may require position information of the UE, which may be obtained from LMF.

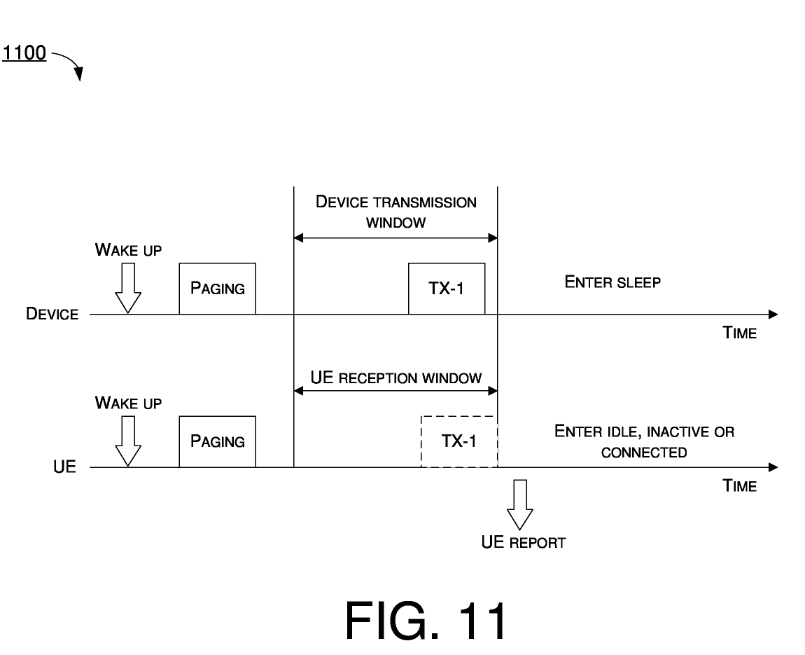

FIG. 11 illustrates an example scenario 1100 in accordance with implementations of the present disclosure. In particular, FIG. 11 depicts the operational process of the device and the UE, as well as the corresponding transmission and reception windows of signals, which may correspond to the scenario illustrated in FIG. 10.

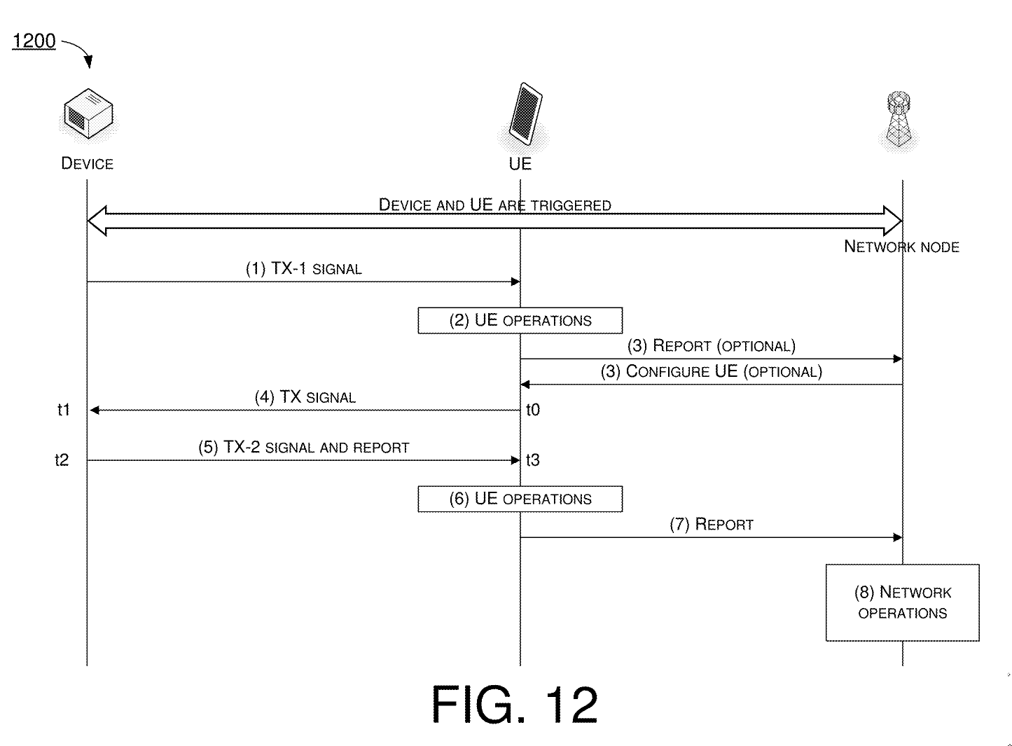

FIG. 12 illustrates an example scenario 1200 in accordance with implementations of the present disclosure. In some implementations, the second type of sensing operation may be performed when the first RRC state of the UE and the second RRC state of the device include an idle mode or an inactive mode. In particular, after being triggered, the device may transmit a first signal to the UE. The UE may receive the first signal from the device and determine a first sensing data based on the first signal. The UE may transmit a second signal to the device. The device may receive the second signal from the UE and transmit a third signal to the UE. The UE may receive the third signal from the device and determine a second sensing data based on the third signal. In some cases, the UE may report at least one of the first sensing data and the second data to the network node.

More specifically, (1) the device may transmit the TX-1 signal based on the corresponding sensing configurations. (2) the UE may search for (i.e., receive) the device’s TX-1 signal in the configured reception window after paging. It should be noted that more than one UE may be configured to perform the sensing operation. Some UEs located in proximity to the device may detect the TX-1 signal, process the received signal, and derive the first sensing data accordingly. The first sensing data may include at least one of a delay parameter, a Doppler parameter, an angle parameter, and an RSSI parameter, depending on the applied sensing way. Such first sensing data may be used to determine a final sensing result, for example, a range or position of the device and/or a position of a target. In some cases, quality information of first sensing data (e.g., SNR, SINR) may be reported to the network node. The network node may use the quality information to select the UE.

Further, (3) the UE may optionally report the first sensing data to the network node. Based on the sensing reports and the respective position information of the UEs, the network node may select one or more UEs to proceed with subsequent sensing operations. It should be noted that (3) may be optional. The UE may directly proceed with subsequent sensing operations without reporting to the network node and without waiting for further configuration from the network node. In some cases, the UE may report the first sensing data via RA or via SDT in inactive mode. The UE may be configured by the network node via RRC, MAC-CE or DCI (when the UE is in connected mode after RA) or via paging (when the UE is in inactive mode). The UE may stay in connected mode or inactive mode to perform the subsequent sensing operations.

Further, (4) at time ‘t0’, the UE may transmit the TX signal based on the corresponding sensing configurations. The transmission time ‘t0’ may be stored by the UE. The TX signal may include RACH preamble and/or UL Sounding Reference Signal (SRS). At time ‘t1’, the device may receive the TX signal and calculate the reception time ‘t1’, and then, (5) transmit the TX-2 signal at time ‘t2’. In some cases, the time difference ‘t2-t1’ may be fixed (i.e., may be predefined in spec or configured by a network node) or not.

In some cases, when the time difference “t2 − t1” is fixed, the fixed time difference may be provided to the UE via configuration information for use in subsequent calculations. In such a case, the device may not need to report additional information to the UE or to the network node.

In some cases, when the time difference “t2 − t1” is not fixed, the device may report sensing data, for example, the time difference “t2 − t1”, to the network node via a UE acting as a relay UE. The relay UE may be the UE that transmits the TX signal or another UE. The sensing data may be reported through a data channel (e.g., A-IoT), sidelink communication, or a non-3GPP interface. If the relay UE is not the UE that transmits the TX signal, the device’s report may be directly forwarded to the network node by the relay UE.

In some cases, when the device receives more than one UE’s TX signals, these TX signals may be within the device’s reception window, and the device may calculate ‘t1’ of each TX signal (assume these Tx signals are based on different sequences or resources).

Further, at time “t3”, the UE may receive the device’s TX-2 signal, (6) process the received signal, and derive second sensing data accordingly. The second sensing data may include a value of “(t3 − t0)” or “((t3 − t0) − (t2 − t1))/2”, which may be used for an RTT-based sensing operation. (7) the UE may report the second sensing data to the network node. The UE may report the second sensing data via RA. After reporting, the UE may transition to an idle mode or remain in, or enter, a connected mode. If the UE enters the connected mode, the UE may further perform positioning-related operations. Thereafter, the network node may determine the device’s range and/or position based on the UE’s position information and the reported sensing data.

Further, (8) the network node may receive the UE’s sensing report, integrate and calculate the device’s range/position, and then report to the server, if present. In some cases, the network node may directly forward the sensing report to the server, and the server may perform the calculation of the device’s range and/or position.

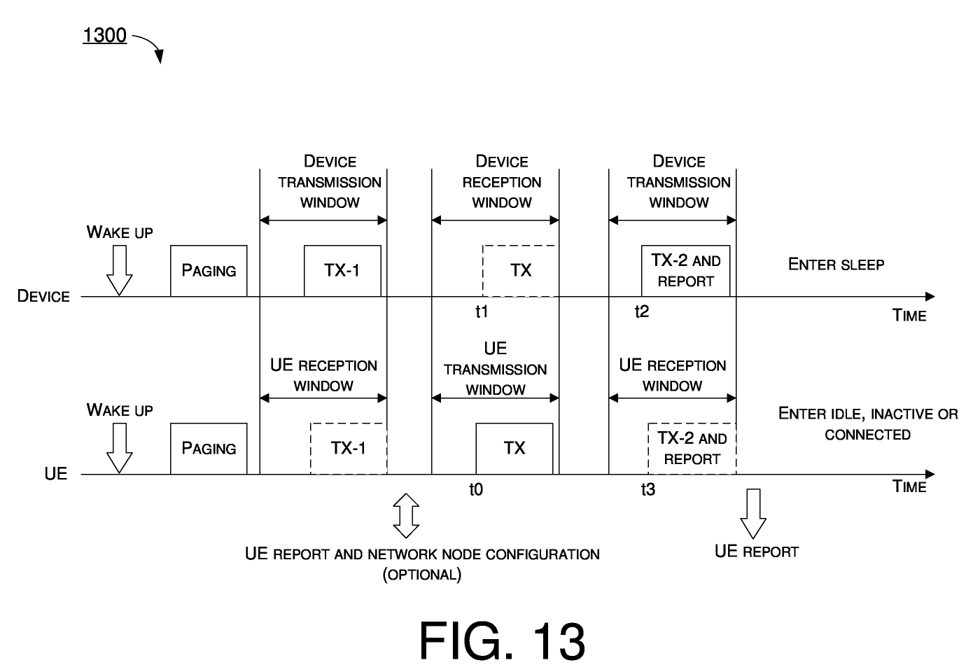

FIG. 13 illustrates an example scenario 1300 in accordance with implementations of the present disclosure. In particular, FIG. 13 depicts the operational process of the device and the UE, as well as the corresponding transmission and reception windows of signals, which may correspond to the scenario illustrated in FIG. 12.

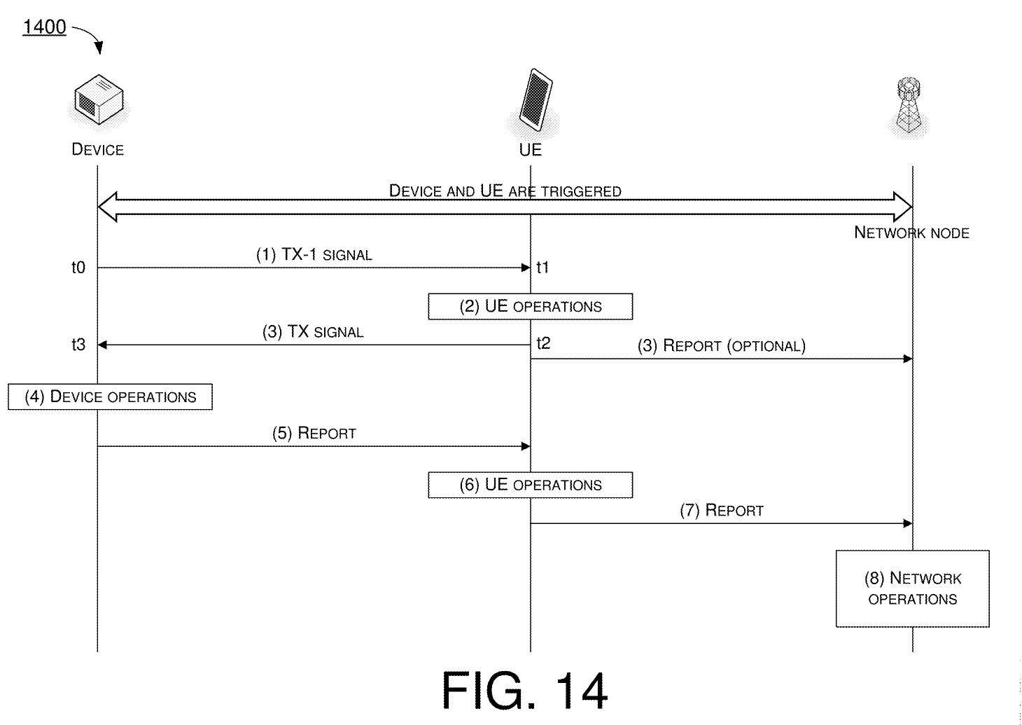

FIG. 14 illustrates an example scenario 1400 in accordance with implementations of the present disclosure. In some implementations, the second type of sensing operation may be performed when the first RRC state of the UE and the second RRC state of the device include an idle mode or an inactive mode. In particular, after being triggered, the device may transmit a first signal to the UE. The UE may receive the first signal from the device and determine a first sensing data based on the first signal. The UE may transmit a second signal to the device. The device may receive the second signal and determine a second sensing data based on the second signal. The device may transmit the second sensing data to the UE. The UE may receive the second sensing data and report the second sensing data to the network node.

More specifically, (1) at time ‘t0’, the device may transmit the TX-1 signal based on the corresponding sensing configurations. The time ‘t0’ may be stored by the device. (2) the UE may search for (i.e., receive) the device’s TX signal in the configured reception window after paging. It should be noted that more than one UE may be configured to perform the sensing operation. At time ‘t1’, some UEs located in proximity to the device may detect the TX-1 signal, process the received signal, and derive sensing data accordingly. The sensing data may include at least one of a delay parameter (e.g., the reception time ‘t1’), a Doppler parameter, an angle parameter, and an RSSI parameter, depending on the applied sensing way. Such sensing data may be used to determine a final sensing result, for example, a range or position of the device and/or a position of a target. The time ‘t1’ may be stored by the UE.

Further, (3) at time ‘t2’, the UE may transmit a transmission (TX) signal, and the transmission time “t2” may be stored by the UE. In some cases, the UE may optionally report the time difference “t2 − t1” to the network node. At time ‘t3’, the device may receive the UE’s TX signal, (4) process the received signal, and derive sensing data accordingly. The sensing data may include a time parameter, such as a delay value corresponding to the reception time “t3”. Based on the stored transmission time “t0” and the reception time “t3”, the device may determine the time difference “t3 − t0”. If the device receives more than one UE’s TX signals, these Tx signals may be within the device’s reception window, the device may calculate ‘t1’ of each TX signal (assume these Tx signals are based on different sequences or resources).

Further, (5) the device may report the second sensing data (e.g., “t3 − t0”) to the network node via a UE acting as a relay UE. The relay UE may be the UE that transmits the TX signal or another UE. The second sensing data may be reported via a data channel (e.g., A-IoT), sidelink communication, or a non-3GPP interface. If the relay UE is not the UE that transmits the TX signal, the device’s report may be directly forwarded to the network node by the relay UE.

Further, (6) and (7) the UE may receive the device’s report and calculate “((t3 − t0) − (t2 − t1)) / 2”, which may be used for an RTT-based sensing operation, and then report the calculated result to the network node. In some cases, the UE may refrain from processing the device’s report and may directly forward the report to the network node. In addition, the UE may separately report its own sensing data (e.g., “t2 − t1”) to the network node.

Further, (8) the network node may receive the UE’s sensing report, perform integration and calculation to determine the device’s range and/or position (for example, by using “((t3 − t0) − (t2 − t1)) / 2” to determine a range between the UE and the device), and may further report the calculated result to a server, if present. In some cases, the network node may directly forward the sensing data to the server, and the server may perform the calculation to determine the device’s range and/or position.

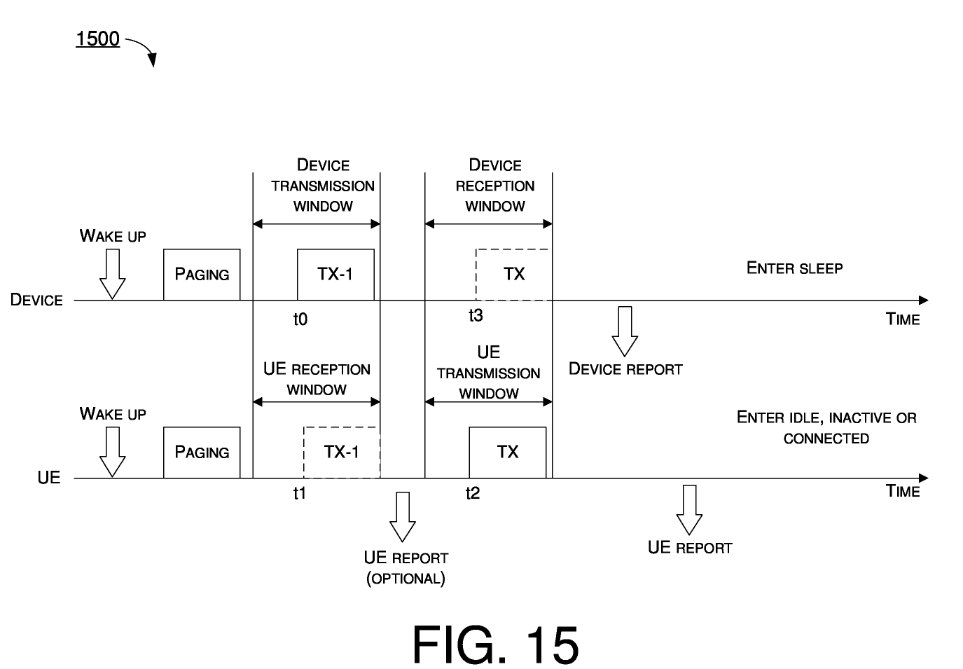

FIG. 15 illustrates an example scenario 1500 in accordance with implementations of the present disclosure. In particular, FIG. 15 depicts the operational process of the device and the UE, as well as the corresponding transmission and reception windows of signals, which may correspond to the scenario illustrated in FIG. 14.

In some implementations, when the first RRC state of the UE includes a connected mode and the second RRC state of the device includes an idle mode or an inactive mode, the sensing operations among the UE, the device, and the network node may be similar to those previously performed when the first RRC state of the UE and the second RRC state of the device include an idle mode or an inactive mode. In some cases, the sensing configuration and configuration mechanisms of the network node, as well as the transmission and reporting procedures, may differ from those applied when the UE operates in an idle mode or an inactive mode. For example, when the UE operates in a connected mode, the network node configures the UE via RRC, MAC-CE or DCI, rather than via paging. Further, the TX signal includes a UL SRS and is not limited to a RACH preamble. In addition, reporting is performed via UCI or UL data transmission, rather than via RA or SDT.

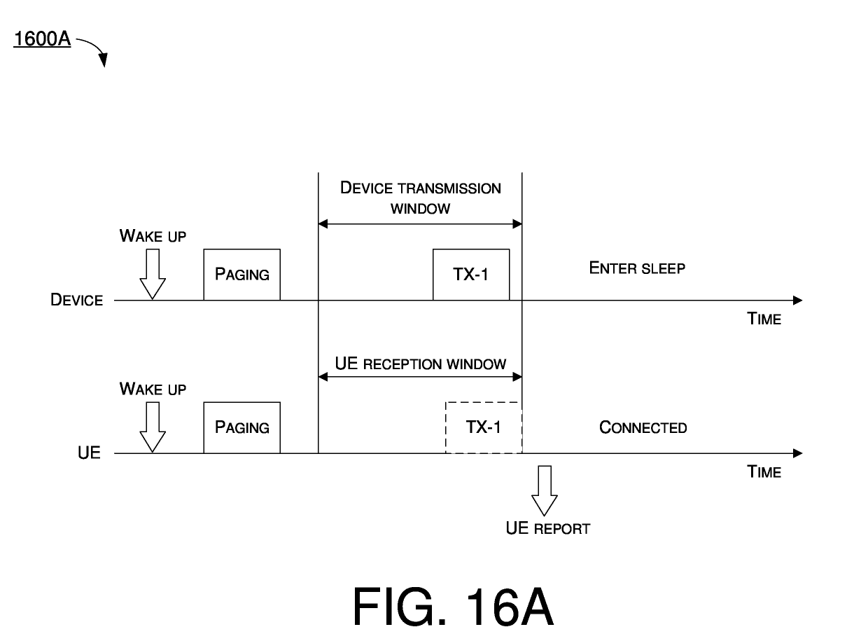

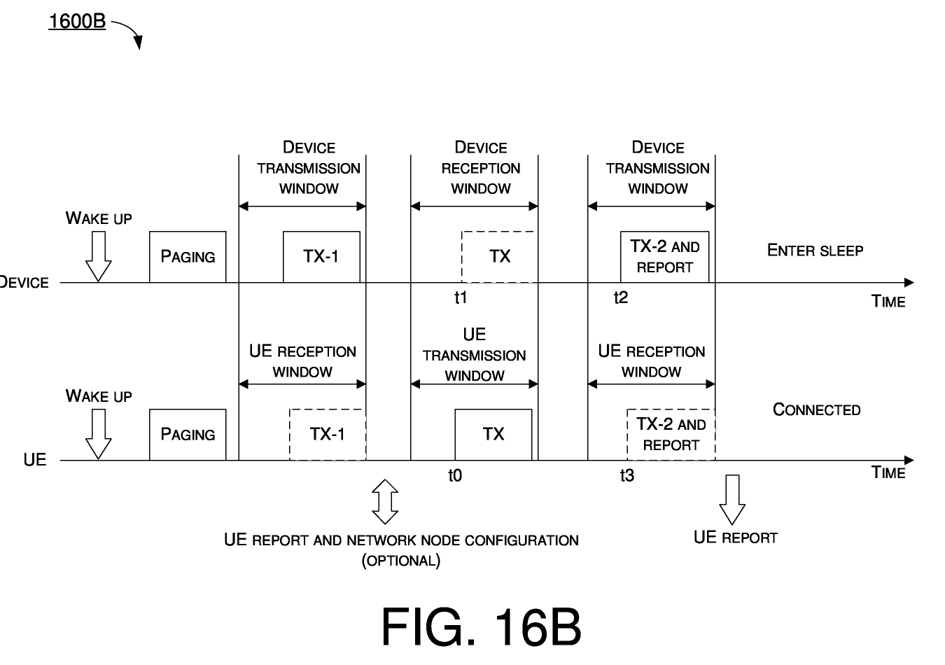

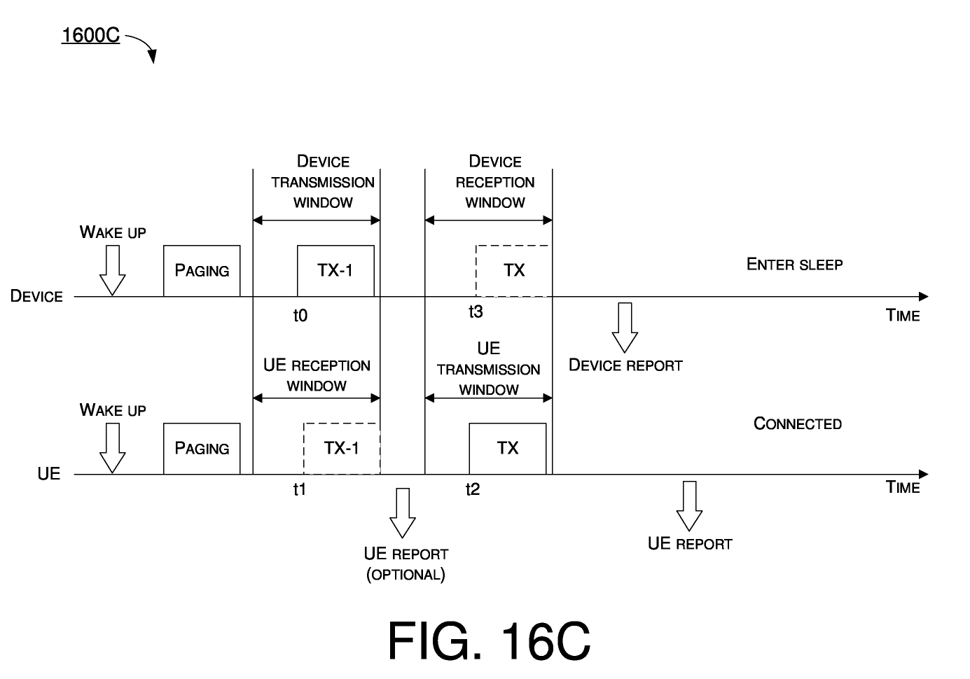

FIGS. 16A to 16C illustrate example scenarios 1600A to 1600C in accordance with implementations of the present disclosure. In particular, FIGS. 16A to 16C depict the operational process of the device and the UE, as well as the corresponding transmission and reception windows of signals, when the first RRC state of the UE includes a connected mode.

In some implementations, when the first RRC state of the UE includes a connected mode and the second RRC state of the device includes a connected mode, the sensing operations among the UE, the device, and the network node may be similar to those previously performed when the first RRC state of the UE and the second RRC state of the device include an idle mode or an inactive mode. In some cases, the sensing configuration and configuration mechanisms of the network node, as well as the transmission and reporting procedures, may differ from those applied when the UE and the device operate in an idle mode or an inactive mode. For example, when the UE and the device operate in a connected mode, the network node configures the UE and the device via RRC, MAC-CE or DCI, rather than via paging. Further, the TX signal includes a UL SRS and is not limited to a RACH preamble. In addition, reporting is performed via UCI or UL data transmission, rather than via RA or SDT.

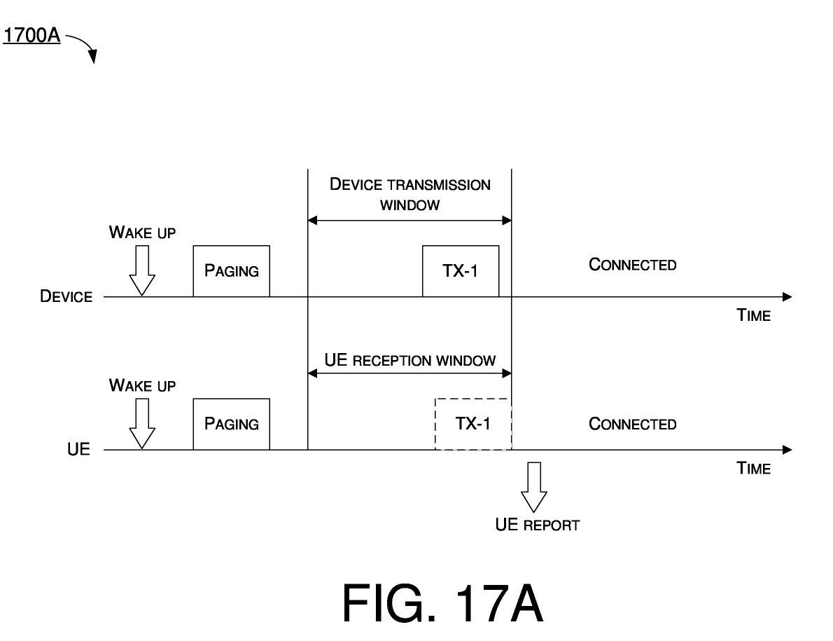

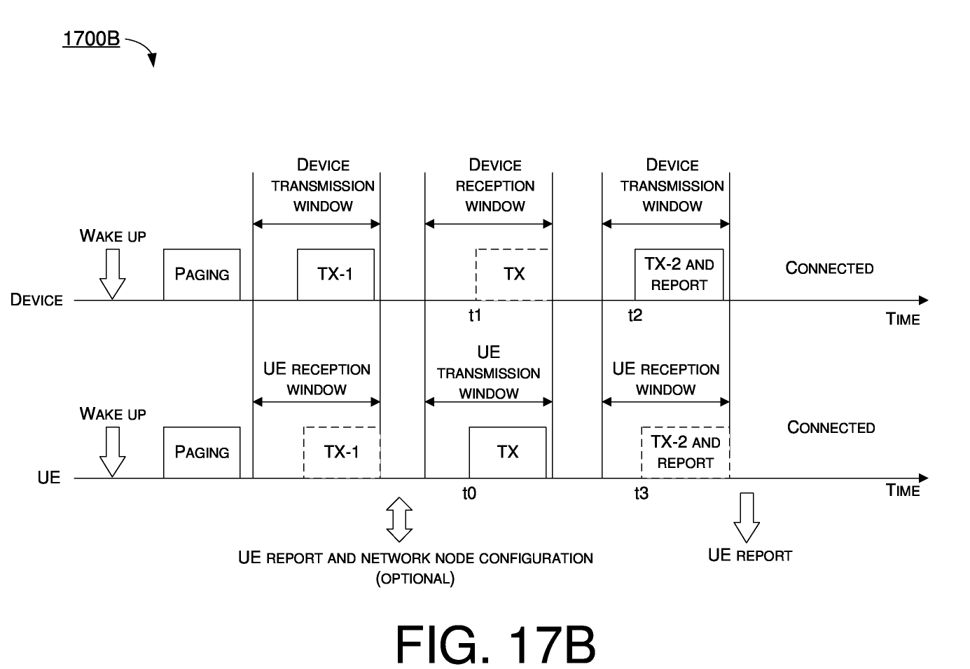

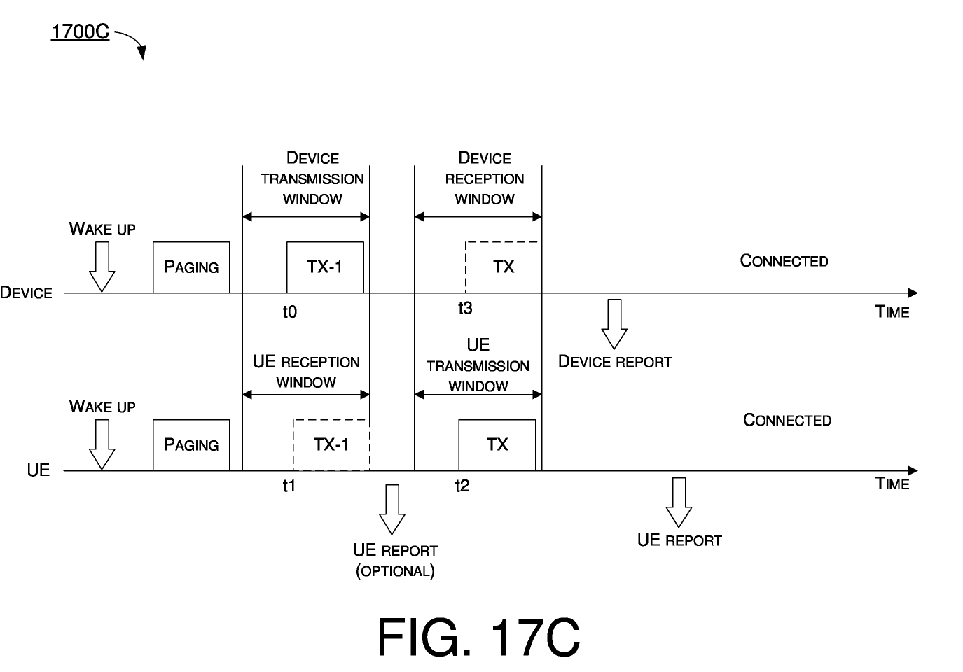

FIGS. 17A to 17C illustrate example scenarios 1700A to 1700C in accordance with implementations of the present disclosure. In particular, FIG. 17A to 17C depict the operational process of the device and the UE, as well as the corresponding transmission and reception windows of signals, when the first RRC state of the UE includes a connected mode and the second RRC state of the device includes a connected mode.

In some implementations, the network node may determine a sensing pair of the UE and the device based on the reported sensing data (e.g., the various sensing data mentioned previously). In particular, based on the reported sensing data of UE(s) and/or device(s), the network node may know which UEs are suitable for the subsequent operations. For example, the UE(s) that detects the device’s TX signal is paired with the device and proceeds to the subsequent operations. For another example, the UE(s) that detects the device’s TX signal and whose own TX signal is detected by the device is paired with the device and proceeds to the subsequent operations.

In some implementations, when more frequent sensing or finer sensing is required, a further step may be performed. In particular, the further step may include at least three sub-steps. The first RRC state of the UE may include an idle mode, an inactive mode or a connected mode based on the service requirement.

In a first sub-step, the network node may reconfigure the UE and the device, which may include updated TX signal configurations (e.g., increased bandwidth) and/or new sensing ways that may differ from those applied in a previous step. In a second sub-step, for a TDoA-based sensing operation, synchronization errors among UEs may need to be maintained within a small range (e.g., on the order of nanoseconds to satisfy positioning requirements). Therefore, additional synchronization procedures may be required prior to performing finer-granularity estimation. In some cases, before transmission of the device’s sensing signal, the UEs may perform DL synchronization operations, for example, based on Tracking Reference Signals (TRS). In some cases, conformance testing (e.g., specified by RAN4) may ensure that a UE’s DL timing error remains within predefined limits. In a third sub-step, the sensing operations may be performed in a manner similar to the previous sensing operations, based on the updated configurations and synchronization conditions.

### Illustrative Implementations

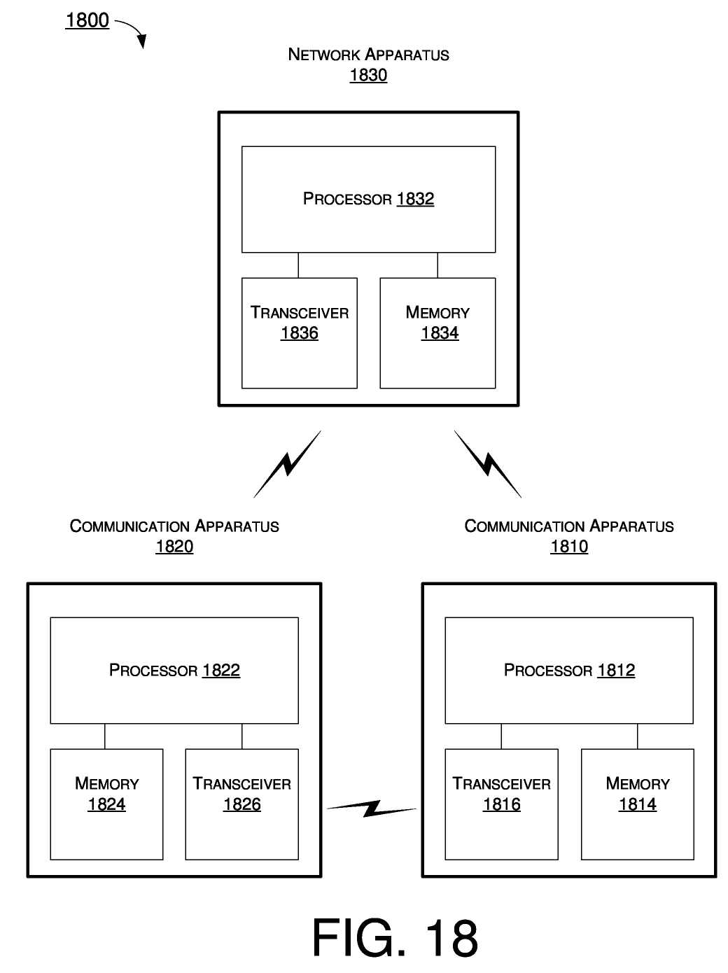

FIG. 18 illustrates an example communication system 1800 having an example communication apparatus 1810, an example communication apparatus 1820, and an example network apparatus 1830 in accordance with an implementation of the present disclosure. Each of communication apparatus 1810, communication apparatus 1820 and network apparatus 1830 may perform various functions to implement schemes, techniques, processes and methods described herein pertaining to performing sensing operations in mobile communications, including scenarios/schemes described above as well as process 1900 and process 2000 described below.

Communication apparatus 1810/1820 may be a part of an electronic apparatus, which may be a UE/device such as a portable or mobile apparatus, a wearable apparatus, a mobile communication apparatus or a computing apparatus. For instance, communication apparatus 1810/1820 may be implemented in a smartphone, a smartwatch, a personal digital assistant, a digital camera, or a computing equipment such as a tablet computer, a laptop computer or a notebook computer. Communication apparatus 1810/1820 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1810/1820 may be implemented in a smart thermostat, a smart fridge, a smart door lock, a wireless speaker or a home control center. Alternatively, communication apparatus 1810/1820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1810/1820 may include at least some of those components shown in FIG. 18 such as a processor 1812/1822, for example. Communication apparatus 1810/1820 may further include one or more other components not pertinent to the proposed scheme of the present disclosure (e.g., internal power supply, display device and/or user interface device), and, thus, such component(s) of communication apparatus 1810/1820 are neither shown in FIG. 18 nor described below in the interest of simplicity and brevity.

Network apparatus 1830 may be a part of a network device, which may be a network node such as a satellite, a base station, a small cell, a router or a gateway. For instance, network apparatus 1830 may be implemented in an eNodeB in an LTE network, in a gNB in a 5G/NR, IoT, NB-IoT or IIoT network or in a satellite or base station in a 6G network. Alternatively, network apparatus 1830 may be implemented in the form of one or more IC chips such as, for example and without limitation, one or more single-core processors, one or more multi-core processors, or one or more RISC or CISC processors. Network apparatus 1830 may include at least some of those components shown in FIG. 8 such as a processor 1832, for example. Network apparatus 1830 may further include one or more other components not pertinent to the proposed scheme of the present disclosure (e.g., internal power supply, display device and/or user interface device), and, thus, such component(s) of network apparatus 1830 are neither shown in FIG. 18 nor described below in the interest of simplicity and brevity.

In one aspect, each of processor 1812, processor 1822 and processor 1832 may be implemented in the form of one or more single-core processors, one or more multi-core processors, or one or more CISC processors. That is, even though a singular term “a processor” is used herein to refer to processor 1812, processor 1822 and processor 1832, each of processor 1812, processor 1822 and processor 1832 may include multiple processors in some implementations and a single processor in other implementations in accordance with the present disclosure. In another aspect, each of processor 1812, processor 1822 and processor 1832 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1812, processor 1822 and processor 1832 is a special-purpose machine specifically designed, arranged and configured to perform specific tasks including performing sensing operations in a device (e.g., as represented by communication apparatus 1810 and communication apparatus 1820) and a network (e.g., as represented by network apparatus 1830) in accordance with various implementations of the present disclosure.

In some implementations, communication apparatus 1810 may also include a transceiver 1816 coupled to processor 1812 and capable of wirelessly transmitting and receiving data. In other words, processor 1812 may transceive the data such as configuration, message, signal, information, indicator, etc. via transceiver 1816. In some implementations, communication apparatus 1810 may further include a memory 1814 coupled to processor 1812 and capable of being accessed by processor 1812 and storing data therein. In some implementations, communication apparatus 1820 may also include a transceiver 1826 coupled to processor 1822 and capable of wirelessly transmitting and receiving data. In other words, processor 1822 may transceive the data such as configuration, message, signal, information, indicator, etc. via transceiver 1826. In some implementations, communication apparatus 1820 may further include a memory 1824 coupled to processor 1822 and capable of being accessed by processor 1822 and storing data therein. In some implementations, network apparatus 1830 may also include a transceiver 1836 coupled to processor 1832 and capable of wirelessly transmitting and receiving data. In other words, processor 1832 may transceive the data such as configuration, message, signal, information, indicator, etc. via transceiver 1836. In some implementations, network apparatus 1830 may further include a memory 1834 coupled to processor 1832 and capable of being accessed by processor 1832 and storing data therein. Accordingly, communication apparatus 1810, communication apparatus 1820 and network apparatus 1830 may wirelessly communicate with each other via transceiver 1816, transceiver 1826 and transceiver 1836, respectively. To aid better understanding, the following description of the operations, functionalities and capabilities of each of communication apparatus 1810, 1820 and network apparatus 1830 is provided in the context of a mobile communication environment in which communication apparatus 1810, 1820 are implemented in or as a communication apparatus or a UE and network apparatus 1830 is implemented in or as a network node of a communication network.

In some implementations, each of memory 1814, 1824 and 1834 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1814,1824 and 1834 may include a type of read-only memory (ROM) such as mask ROM, programmable ROM (PROM), erasable programmable ROM (EPROM) and/or electrically erasable programmable ROM (EEPROM). Alternatively, or additionally, each of memory 1814, 1824 and 1834 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

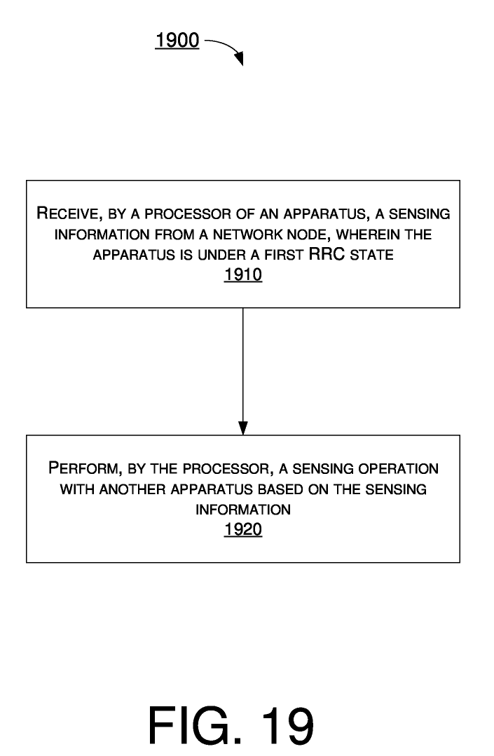

FIG. 19 illustrates an example process 1900 in accordance with an implementation of the present disclosure. Process 1900 may be an example implementation of above scenarios/schemes, whether partially or completely, with respect to performing sensing operations in mobile communications of the present disclosure. Process 1900 may represent an aspect of implementation of features of communication apparatus 1810/1820. Process 1900 may include one or more operations, actions, or functions as illustrated by one or more of blocks 1910 and 1920. Although illustrated as discrete blocks, various blocks of process 1900 may be divided into additional blocks, combined into fewer blocks, or eliminated, depending on the desired implementation. Moreover, the blocks of process 1900 may be executed in the order shown in FIG. 19 or, alternatively, in a different order. Process 1900 may be implemented by communication apparatus 1810/1820 or any suitable communication device or machine type devices. Solely for illustrative purposes and without limitation, process 1900 is described below in the context of communication apparatus 1810/1820. Process 1900 may begin at block 1910.

At block 1910, process 1900 may involve processor 1812/1822 of communication apparatus 1810/1820 receiving a sensing information from a network node. Communication apparatus 1810/1820 may be under a first RRC state. Process 1900 may proceed from block 1910 to block 1920.

At block 1920, process 1900 may involve processor 1812/1822 performing a sensing operation with another apparatus based on the sensing information. The another apparatus may be under a second RRC state.

In some implementations, the sensing information may include a sensing configuration and a sensing indication, and the sensing information is carried on at least one of a SIB and a paging message.

In some implementations, the sensing configuration information may be further carried on a PDSCH indicated by the paging message.

In some implementations, the first RRC state may include an idle mode, an inactive mode or a connected mode, and the second RRC state may include an idle mode, an inactive mode or a connected mode.

In some implementations, the sensing operation may include: receiving a signal from the another apparatus; determining a sensing data based on the signal; and reporting the sensing data to the network node.

In some implementations, the sensing data may include at least one of a delay parameter, a Doppler parameter, an angle parameter, and a RSSI parameter.

In some implementations, the sensing operation may include: receiving a first signal from the another apparatus; determining a first sensing data based on the first signal; transmitting a second signal to the another apparatus; receiving a third signal from the another apparatus; determining a second sensing data based on the second signal and the third signal; and reporting the second sensing data to the network node.

In some implementations, the sensing operation may include: reporting the first sensing data to the network node.

In some implementations, the first sensing data may include at least one of delay parameter, Doppler parameter, angle parameter, RSSI parameter, and quality parameter, and the second sensing data may include time parameter.

In some implementations, the sensing operation may include: receiving a first signal from the another apparatus; determining a first sensing data based on the first signal; transmitting a second signal to the another apparatus for determining a second sensing data; receiving the second sensing data from the another apparatus; and reporting the second sensing data to the network node.

In some implementations, the sensing operation may include: reporting the first sensing data to the network node.

In some implementations, the first sensing data may include at least one of a delay parameter, a Doppler parameter, an angle parameter, an RSSI parameter, and a quality parameter, and the second sensing data may include a time parameter.

In some implementations, the sensing operation may include: transmitting a signal to the another apparatus for determining a sensing data.

In some implementations, the sensing operation may include: transmitting a first signal to the another apparatus for determining a first sensing data based on the first signal; receiving a second signal from the another apparatus; transmitting a third signal to the another apparatus for determining a second sensing data based on the second signal and the third signal.

In some implementations, the sensing operation may include: transmitting a first signal to the another apparatus for determining a first sensing data; receiving a second signal from the another apparatus; determining a second sensing data based on the second signal; and transmitting the second sensing data to the another apparatus.

In some implementations, the second sensing data may include a time parameter.

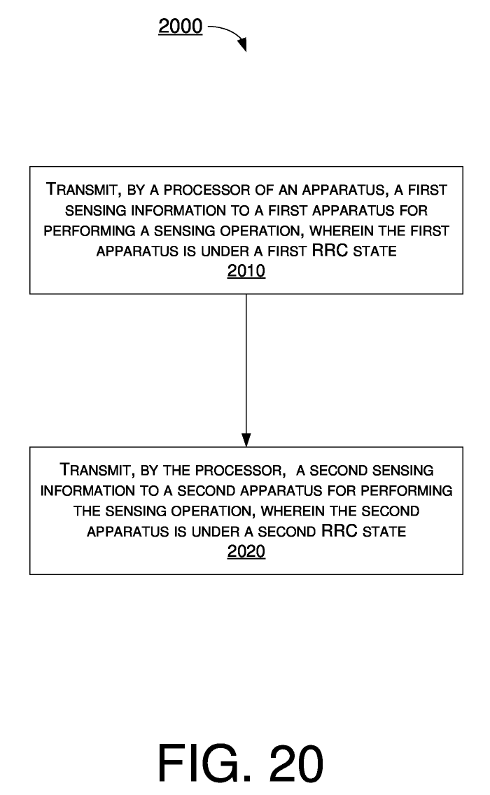

FIG. 20 illustrates an example process 2000 in accordance with an implementation of the present disclosure. Process 2000 may be an example implementation of above scenarios/schemes, whether partially or completely, with respect to performing sensing operations in mobile communications of the present disclosure. Process 2000 may represent an aspect of implementation of features of communication apparatus 1820. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks of process 2000 may be executed in the order shown in FIG. 20 or, alternatively, in a different order. Process 2000 may be implemented by network apparatus 1830 or any suitable network device or machine type devices. Solely for illustrative purposes and without limitation, process 2000 is described below in the context of network apparatus 1830. Process 2000 may begin at block 2010.

At block 2010, process 2000 may involve processor 1832 of network apparatus 1830 transmitting a first sensing information to a first apparatus for performing a sensing operation. The first apparatus may be under a first RRC state. Process 2000 may proceed from block 2010 to block 2020.

At block 2020, process 2000 may involve processor 1832 of network apparatus 1830 transmitting a second sensing information to a second apparatus for performing the sensing operation. The second apparatus may be under a second RRC state.

In some implementations, each of the first sensing information and the second sensing information may include a sensing configuration and a sensing indication, and the sensing information may be carried on at least one of a SIB and a paging message.

In some implementations, the sensing configuration information may be further carried on a PDSCH indicated by the paging message.

In some implementations, the first RRC state may include an idle mode, an inactive mode or a connected mode, and the second RRC state may include an idle mode, an inactive mode or a connected mode.

In some implementations, process 2000 may further involve processor 1832 receiving a sensing data from the first apparatus.

In some implementations, process 2000 may further involve processor 1832 determining a sensing pair of the first apparatus and the second apparatus based on the sensing data.

In some implementations, the sensing data may include at least one of a delay parameter, a Doppler parameter, an angle parameter, and a RSSI parameter.

In some implementations, process 2000 may further involve processor 1832 receiving a first sensing data and a second sensing data from the first apparatus.

In some implementations, process 2000 may further involve processor 1832 determining a sensing pair of the first apparatus and the second apparatus based on the first sensing data and the second sensing data.

In some implementations, the first sensing data may include at least one of a delay parameter, a Doppler parameter, an angle parameter, an RSSI parameter, and a quality parameter, and the second sensing data may include a time parameter.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a sensing information from a network node, wherein the apparatus is under a first Radio Resource Control (RRC) state; and
performing, by the processor, a sensing operation with another apparatus based on the sensing information, wherein the another apparatus is under a second RRC state.

2. The method of claim 1, wherein the sensing information includes a sensing configuration and a sensing indication, and wherein the sensing information is carried on at least one of a System Information Block (SIB) and a paging message.

3. The method of claim 2, wherein the sensing configuration information is further carried on a Physical Downlink Shared Channel (PDSCH) indicated by the paging message.

4. The method of claim 1, wherein the first RRC state includes an idle mode, an inactive mode or a connected mode, and wherein the second RRC state includes an idle mode, an inactive mode or a connected mode.

5. The method of claim 1, wherein the sensing operation comprises:
receiving, by the processor, a signal from the another apparatus;
determining, by the processor, a sensing data based on the signal; and
reporting, by the processor, the sensing data to the network node.

6. The method of claim 5, wherein the sensing data includes at least one of a delay parameter, a Doppler parameter, an angle parameter, and a Received Signal Strength Indicator (RSSI) parameter.

7. The method of claim 1, wherein the sensing operation comprises:
receiving, by the processor, a first signal from the another apparatus;
determining, by the processor, a first sensing data based on the first signal;
transmitting, by the processor, a second signal to the another apparatus;
receiving, by the processor, a third signal from the another apparatus;
determining, by the processor, a second sensing data based on the second signal and the third signal; and
reporting, by the processor, the second sensing data to the network node.

8. The method of claim 7, wherein the sensing operation comprises:
reporting, by the processor, the first sensing data to the network node.

9. The method of claim 7, wherein the first sensing data includes at least one of a delay parameter, a Doppler parameter, an angle parameter, a Received Signal Strength Indicator (RSSI) parameter, and a quality parameter, and the second sensing data includes a time parameter.

10. The method of claim 1, wherein the sensing operation comprises:
receiving, by the processor, a first signal from the another apparatus;
determining, by the processor, a first sensing data based on the first signal;
transmitting, by the processor, a second signal to the another apparatus for determining a second sensing data;
receiving, by the processor, the second sensing data from the another apparatus; and
reporting, by the processor, the second sensing data to the network node.

11. The method of claim 10, wherein the sensing operation comprises:
reporting, by the processor, the first sensing data to the network node.

12. The method of claim 10, wherein the first sensing data includes at least one of a delay parameter, a Doppler parameter, an angle parameter, a Received Signal Strength Indicator (RSSI) parameter, and a quality parameter, and the second sensing data includes a time parameter.

13. The method of claim 1, wherein the sensing operation comprises:
transmitting, by the processor, a signal to the another apparatus for determining a sensing data.

14. The method of claim 1, wherein the sensing operation comprises:
transmitting, by the processor, a first signal to the another apparatus for determining a first sensing data based on the first signal;
receiving, by the processor, a second signal from the another apparatus;
transmitting, by the processor, a third signal to the another apparatus for determining a second sensing data based on the second signal and the third signal.

15. The method of claim 1, wherein the sensing operation comprises:
transmitting, by the processor, a first signal to the another apparatus for determining a first sensing data;
receiving, by the processor, a second signal from the another apparatus;
determining, by the processor, a second sensing data based on the second signal; and
transmitting, by the processor, the second sensing data to the another apparatus.

16. A method, comprising:
transmitting, by a processor of an apparatus, a first sensing information to a first apparatus for performing a sensing operation, wherein the first apparatus is under a first Radio Resource Control (RRC) state; and
transmitting, by the processor, a second sensing information to a second apparatus for performing the sensing operation, wherein the second apparatus is under a second RRC state.

17. The method of claim 16, further comprising:
receiving, by the processor, a sensing data from the first apparatus.

18. The method of claim 17, further comprising:
determining, by the processor, a sensing pair of the first apparatus and the second apparatus based on the sensing data.

19. The method of claim 16, further comprising:
receiving, by the processor, a first sensing data and a second sensing data from the first apparatus.

20. An apparatus, comprising:
a transceiver which, during operation, wirelessly communicates with a wireless network; and
a processor communicatively coupled to the transceiver such that, during operation, the processor performs operations comprising:
receiving, via the transceiver, a sensing information from a network node, wherein the apparatus is under a first Radio Resource Control (RRC) state; and
performing a sensing operation with another apparatus based on the sensing information, wherein the another apparatus is under a second RRC state.
